(19) United States
(12) Patent Application Publication
(10) Pub. No.: US 2015/0181527 A1
(43) Pub. Date: Jun. 25, 2015

(54) DRIVE CONTROL METHOD OF RECEPTION UNIT AND POSITIONING DEVICE

(71) Applicant: Seiko Epson Corporation, Shinjuku-ku (JP)

(72) Inventors: Yoshihiro YAMAMURA, Matsumoto-shi (JP); Ryota Hirakawa, Shiojiri-shi (JP)

(21) Appl. No.: 14/572,090

(22) Filed: Dec. 16, 2014

(30) Foreign Application Priority Data
Dec. 20, 2013 (JP) 2013-263485

(51) Int. Cl. H04W 52/02; H04W 4/02

(52) U.S. Cl. CPC H04W 52/0251; H04W 4/02; H04W 52/0261

(57) ABSTRACT

A portable electronic device includes a reception unit (GPS receiver) that receives a positioning signal, and a power supply unit that supplies the reception unit (GPS receiver) with power. An intermittent operation range including an upper limit of an operation ratio of the reception unit (GPS receiver) is set, based on power consumption status of the power supply unit. The reception unit (GPS receiver) is intermittently operated within the intermittent operation range that is set.

The entire disclosure of Japanese Patent Application No. 2013-263485, filed Dec. 20, 2013 is hereby expressly incorporated by reference herein.

### BACKGROUND

1. Technical Field

The present invention relates to a drive control method of a reception unit or the like.

2. Related Art

Portable electronic devices on which positioning devices represented by Global Positioning System (GPS) receivers are mounted have become widespread. The positioning device receives positioning signals which are GPS satellite signals and the like so as to measure and output positions, speeds, and the like, but when the positioning devices are mounted on the portable electronic devices, saving power consumption is required in order to extend measurement time. For example, JP-A-10-332414 discloses a technology of enabling a reduction in power consumption by changing a reception interval of a GPS satellite signal depending on a movement distance.

However, in the technology of JP-A-10-332414 described above, a reception interval of the GPS satellite signals may be long, for example, one minute, and thus there is a disadvantage in that position logs cannot be acquired when the GPS satellite signals are not received. During intermittent positioning in which the reception interval is long, it is difficult to capture continuous GPS satellite signals, which can lead to a decrease in an accuracy of the measured position, and prolonged time required for positioning.

### SUMMARY

An advantage of some aspects of the invention is to provide a new method for saving power in a positioning device that receives a positioning signal.

A first aspect of the invention is directed to a drive control method of a reception unit including setting an intermittent operation range including an upper limit of an operation ratio of the reception unit, based on power consumption status of a power supply unit that supplies the reception unit which receives a positioning signal with power; and causing the reception unit to perform an intermittent operation within the intermittent operation range.

As another aspect, the invention may be configured as a positioning device including a reception unit that receives a positioning signal; a power supply unit that supplies the reception unit with power; a setting unit that sets an intermittent operation range including an upper limit of an operation ratio of the reception unit, based on power consumption status of the power supply unit; and a control unit that causes the reception unit to perform an intermittent operation within the intermittent operation range.

According to the first aspect and the like, it is possible to realize a new method for saving power in the positioning device. In other words, the reception unit that receives the positioning signal operates intermittently, within the intermittent operation range which is set based on the power consumption status of the power supply unit. Thus, it is possible to control the upper limit of the consumed power amount by the reception unit, for example, by setting the upper limit of the operation ratio of the reception unit to be low, according to the power consumption status.

As a second aspect of the invention, the drive control method of a reception unit may be configured such that the setting is setting the intermittent operation range by determining the power consumption status by using the remaining amount of power in the power supply unit.

According to the second aspect, the power consumption status is determined using the remaining amount of power in the power supply unit. For example, when the remaining amount of power is “small”, an intermittent operation range is set so as to have a low upper limit, such that it is possible to reduce the consumed power amount in the power supply unit and extend an operation time of the positioning device.

As a third aspect of the invention, the drive control method of a reception unit may be configured such that the setting is setting the intermittent operation range by determining the power consumption status by using an output voltage of the power supply unit.

According to the third aspect of the invention, the power consumption status is determined using the output voltage of the power supply unit. With a decrease in the remaining amount in power of the power supply unit, the output voltage of the power supply unit is reduced. Thus, for example, a threshold voltage of the output voltage is set at which the remaining amount of power is considered to be “small”, and if the output voltage is less than the threshold voltage, the intermittent operation range is set so as to have a reduced upper limit, such that it is possible to reduce the consumed power amount of the reception unit and extend the operation time of the positioning device.

As a fourth aspect of the invention, the drive control method of a reception unit may be configured such that the setting is setting the intermittent operation range by determining the power consumption status by using a positioning operation time.

According to the fourth aspect of the invention, the power consumption status is determined using the positioning operation time. With an increase in the positioning operation time, the remaining amount of power in the power supply unit is reduced. Thus, for example, a threshold time of the positioning operation time is set at which the remaining amount of power is considered to be “small”, and if the positioning operation time reaches the threshold time, the intermittent operation range is set so as to have a reduced upper limit, such that it is possible to reduce the consumed power amount in the power supply unit and extend the operation time of the positioning device.

As a fifth aspect of the invention, the drive control method of a reception unit may be configured to further include setting the intermittent operation range, based on a movement speed measured by using the positioning signal.

According to the fifth aspect of the invention, the intermittent operation range is set based on the movement speed.

As a sixth aspect of the invention, the drive control method of a reception unit may be configured to further include setting the intermittent operation range, based on whether a position measured by using the positioning signal satisfies a predetermined position condition.

According to the sixth aspect of the invention, the intermittent operation range is set, based on whether the measured position satisfies the predetermined position condition.

As a seventh aspect of the invention, the drive control method of a reception unit may be configured to further include variably setting the intermittent operation range, according to a data portion of a navigation message carried on the positioning signal which is received by the reception unit.

According to the seventh aspect, the intermittent operation range is variably set according to the data portion of the navigation message carried on the positioning signal. In the positioning using the positioning signal, a predetermined data portion (ephemeris in a GPS) of the navigation message is required. Therefore, the intermittent operation range is set so as to increase the upper limit while the predetermined data portion is received, such that it is possible to perform the positioning by reliably receiving the predetermined data portion.

### BRIEF DESCRIPTION OF THE DRAWINGS

The invention will be described with reference to the accompanying drawings, wherein like numbers reference like elements.

FIGS. 1A and 1B are external views of a portable electronic device.

FIG. 2 is a configuration diagram of a portable electronic device.

FIG. 3 is an overview of an intermittent operation.

FIG. 4 is a configuration diagram of a baseband processing circuit unit.

FIG. 5 is a data configuration example of an operation range setting table.

FIG. 6 is a data configuration example of an operation ratio setting table.

FIG. 7 is a flowchart of a baseband process.

### DESCRIPTION OF EXEMPLARY EMBODIMENTS

### External Configuration

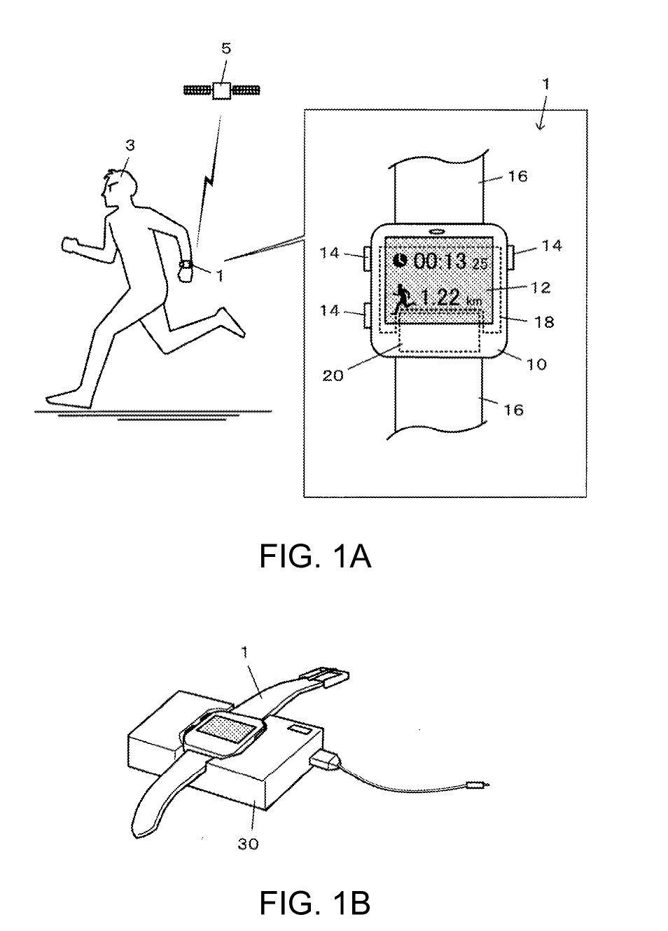

FIG. 1A is a configuration example of a portable electronic device 1 of the present embodiment. The portable electronic device 1 is mountable on the wrist or the arm of the user 3, similarly to a wristwatch, and is a wearable computer which is referred to as a so-called runner's watch. Since a positioning device is built into the portable electronic device 1, the portable electronic device 1 is also the positioning device. A display 12 that displays various types of data or the like based on time and position measurement information is provided on the upper surface of a main frame 10 of the portable electronic device 1. An operation switch 14 allowing the user 3 to perform various operation inputs and a band 16 for mounting the portable electronic device 1 on the wrist or the arm of the user 3 are provided on the side surface of the main frame 10.

The main frame 10 forms a hermetic chamber, and a control board 18 electrically connected to the display 12, the operation switch 14, and the like and a rechargeable battery 20 that supplies power to the control board 18 and the like are built therein.

A Central Processing Unit (CPU), a main memory, a measurement data memory, a position measurement module, and a short range wireless module are mounted on the control board 18. The main memory is a storage medium for storing a program, initial setting data, and an operation result of the CPU, and is configured with a Read Only Memory (ROM), a Random Access Memory (RAM), a flash memory, and the like. The measurement data memory is a storage medium for storing measurement data including position measurement information, and is configured with a rewritable non-volatile memory such as a flash memory, a ferroelectric memory (FeRAM), and a magnetoresistive memory (MRAM).

The position measurement module is a positioning device that receives signals from a position measurement system, and generates and outputs position measurement information at a predetermined period (every one second). In the present embodiment, a GPS is used as the position measurement system. In other words, the position measurement module is also referred to as a GPS module or a GPS receiver. The position measurement information contains the position measurement date and time (Coordinated Universal Time (UTC)), coordinates represented by latitude and longitude, speed, and the like. In addition, the position measurement system is not limited to the GPS, and may use other satellite navigation systems.

A charging method of the battery 20 may be configured in such a manner that the portable electronic device 1 is set on a cradle 30 connected to a domestic power supply, for example, as illustrated in FIG. 1B, and charged through the cradle 30 through an electrical contact provided on the back surface of the main frame 10, or may be charged in a wireless manner (charging through so-called non-contact power transmission or wireless point charging).

### Functional Configuration

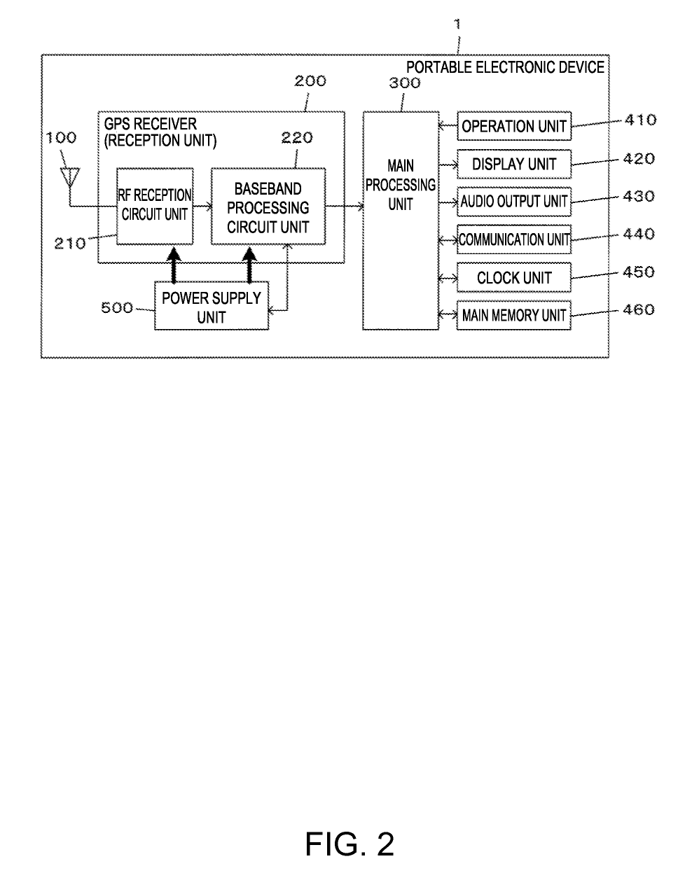

FIG. 2 is a block diagram illustrating an internal configuration of the portable electronic device 1. As illustrated in FIG. 2, the portable electronic device 1 is configured to include a GPS antenna 100, a GPS receiver 200, a main processing unit 300, an operation unit 410, a display unit 420, a audio output unit 430, a communication unit 440, a clock unit 450, a main memory unit 460, and a power supply unit 500.

The GPS antenna 100 is an antenna for receiving a Radio Frequency (RF) signal including a GPS satellite signal which is transmitted form a GPS satellite.

The GPS receiver 200 is a positioning device that receives the GPS satellite signal, and is an example of a reception unit. Further, the GPS receiver 200 calculates the position, the speed, and the like of the GPS receiver 200, based on a navigation message such as orbit information (ephemeris and almanac) of the GPS satellite that is transported while being superimposed on the GPS satellite signal received by the GPS antenna. The GPS receiver 200 corresponds to the position measurement module mounted on the control board 18 in FIGS. 1A and 1B. Further, the GPS receiver 200 is configured to include an RF reception circuit unit 210, and a baseband processing circuit unit 220. Further, the RF reception circuit unit 210 and the baseband processing circuit unit 220 may be produced as respective separate Large Scale Integrated circuits (LSI), or as one chip.

The RF reception circuit unit 210 down-converts the RF signal received by the GPS antenna 100 into a signal of an intermediate frequency, amplifies the down-converted signal or the like, and converts the signal into a digital signal so as to output the converted signal. The baseband processing circuit unit 220 captures and tracks a GPS satellite signal, by using data of the reception signal through the RF reception circuit unit 210, and calculates the position of the GPS receiver 200 and the clock error, by using time information, satellite orbit information, and the like which are extracted from the acquired GPS satellite signal. Description has been given of the case in which the GPS receiver 200 is the reception unit in the present embodiment, but it is possible to apply the invention to a case in which the RF reception circuit unit 210 is the reception unit.

The main processing unit 300 is a processor that generally controls each section of the portable electronic device 1 according to various programs such as a system program stored in the main memory unit 460, and is configured to include a processor such as a CPU. The main processing unit 300 corresponds to the CPU mounted on the control board 18 in FIGS. 1A and 1B.

The operation unit 410 is an input device configured with a touch panel, a button switch, and the like, and outputs an operation signal in response to an operation of the user to the main processing unit 300. The operation unit 410 corresponds to the operation switch 14 in FIGS. 1A and 1B.

The display unit 420 is a display device configured with a Liquid Crystal Display (LCD), and the like, and performs various types of display based on a display signal from the main processing unit 300. The display unit 420 corresponds to the display 12 in FIGS. 1A and 1B.

The audio output unit 430 is an audio output device configured with a speaker and the like, and performs various types of audio output based on the audio signal from the main processing unit 300.

The communication unit 440 is realized by wireless communication devices such as a wireless Local Area Network (LAN) or Bluetooth (registered trademark), and performs communication with external devices. The communication unit 440 corresponds to the short range wireless module mounted on the control board 18 in FIGS. 1A and 1B.

The clock unit 450 is an internal clock, is configured with an oscillation circuit including a quartz oscillator or the like, and counts the current time, and elapsed time from a specified timing.

The main memory unit 460 is a storage device configured with a Read Only Memory (ROM), a Random Access Memory (RAM), and the like, stores a system program by which the main processing unit 300 generally controls each section of the portable electronic device 1 and programs and data for implementing various functions of the portable electronic device 1, is used as a work area of the main processing unit 300, and temporarily stores an operation result of the main processing unit 300, operation data from the operation unit 410, and the like. The main memory unit 460 corresponds to the main memory and the measurement data memory mounted on the control board 18 in FIGS. 1A and 1B.

The power supply unit 500 is a power supply device that supplies power to respective units of the portable electronic device 1, in response to power control signals from the baseband processing circuit unit 220 and the main processing unit 300, and is configured with a secondary battery. In FIG. 2, the power supply to the RF reception circuit unit 210 and the baseband processing circuit unit 220 is indicated by bold arrows. The power supply unit 500 corresponds to the battery 20 in FIGS. 1A and 1B.

### Principle

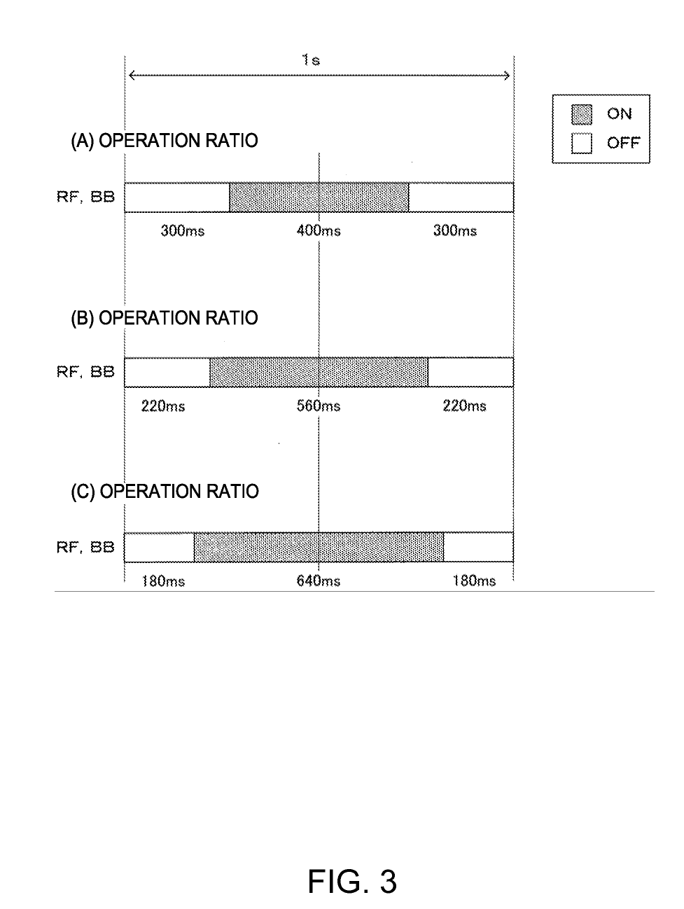

In the present embodiment, the GPS receiver 200 saves power by intermittently operating the RF reception circuit unit 210 and the baseband processing circuit unit 220. FIG. 3 is a diagram illustrating an overview of an intermittent drive. As illustrated in FIG. 3, so-called duty control is performed in which a period of the operation state being in the ON state (ON period) and a period of the operation state being in the OFF state (OFF period) are repeated for a predetermined period, with an output time interval of position calculation (for example, one second) as a unit period, such that the RF reception circuit unit 210 and the baseband processing circuit unit 220 synchronize with each other.

The ON state of the RF reception circuit unit 210 is an operation state in which power is supplied to the RF reception circuit unit 210 from the power supply unit 500, and circuit operations (reception operations) are performed which include amplification of the RF signal received in the GPS antenna 100, down-conversion into the signal of an intermediate frequency (IF signal), cutoff of unnecessary frequency band components, and conversion of a reception signal which is an analog signal into a digital signal. Further, the OFF state is an operation state in which power is not supplied to the RF reception circuit unit 210 from the power supply unit 500, and the circuit operations described above are not performed. Furthermore, the OFF state may be an operation state in which power is supplied to a portion of the RF reception circuit unit 210, and is not supplied to the other portion.

The ON state of the baseband processing circuit unit 220 is an operation state in which operations for performing the acquisition process and the position calculation process of the GPS satellite and a process according to the intermittent operation control can be performed. Further, the OFF state is an operation state in which a process according to the intermittent operation control can be performed, without performing the acquisition process and the position calculation process described above (pause of operation), and can be also referred to as a so-called sleep state. In addition, in the OFF state, the number of operation clocks may be reduced compared to those in the ON state.

The operation ratio (duty ratio) of the intermittent operation which is the ratio of the ON period relative to the unit period is variably set depending on the reception status of the GPS satellite signal. In the present embodiment, the reception signal intensity is considered to be the reception status, and the stronger the reception signal intensity is, the weaker the operation ratio is. FIG. 3 illustrates the cases in which the operation ratios are respectively (a) 40%, (b) 56%, and (c) 64% from the top. The pattern of a temporal arrangement of an ON period and an OFF period in a unit period is referred to as an intermittent drive pattern.

The intermittent drive pattern is arranged such that the central time of the ON period matches the central time of the unit period. Thus, even if the measurement data in the unit period is integrated and averaged regardless of the operation ratio, the measurement time in the unit period is the central time of the unit period. In other words, even when changing the operation ratio, the interval of the measurement time is constant. Accordingly, even when changing the intermittent drive pattern from time to time, the output time interval of the measured position can be maintained to be constant.

The operation range of the intermittent operation which is a range of the settable operation ratio is variably set depending on the power consumption status of the power supply unit 500. In the present embodiment, the lower limit of the operation range is fixed to “0%”, and the upper limit is set depending on the power consumption status of the power supply unit 500. Further, the remaining amount of power in the power supply unit 500 is regarded as the power consumption status, and the smaller the remaining amount of power is, the lower the upper limit of the operation range is set.

### Configuration of Baseband Processing Circuit Unit

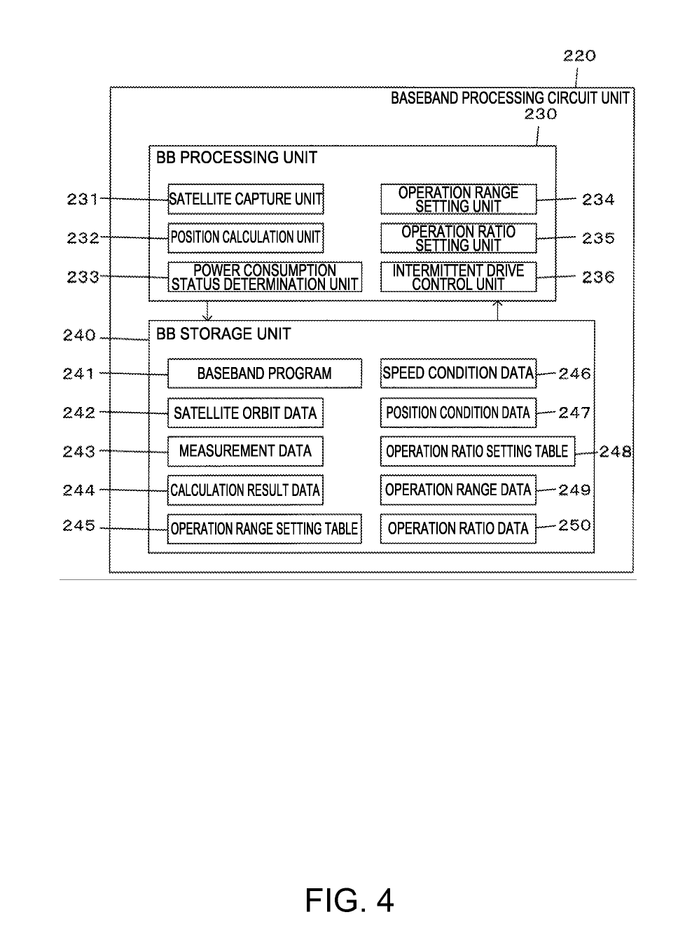

FIG. 4 is a functional configuration diagram of the baseband processing circuit unit 220. As illustrated in FIG. 4, the baseband processing circuit unit 220 includes a BB processing unit 230 and a BB storage unit 240.

The BB processing unit 230 is implemented by a processor of a CPU or a DSP, or the like, and generally controls each section of the baseband processing circuit unit 220. Further, the BB processing unit 230 includes a satellite capture unit 231, a position calculation unit 232, a power consumption status determination unit 233, an operation range setting unit 234, an operation ratio setting unit 235, and an intermittent drive control unit 236.

The satellite capture unit 231 performs a digital signal process such as carrier removal or correlation calculation on data of the reception signal from the RF reception circuit unit 210 so as to capture GPS satellites (GPS satellite signals).

The position calculation unit 232 acquires the satellite orbit data 242 and the measurement data 243 for each of GPS satellites captured by the satellite capture unit 231, and performs a position calculation process by using the acquired data so as to calculate the position, the clock error, and the movement speed of the GPS receiver 200. A well-known method such as a least square method or Kalman filter may be applied to the position calculation process. Data regarding position and speed calculated by the position calculation unit 232 is stored and accumulated as calculation result data 244.

The satellite orbit data 242 is data such as the almanac or the ephemeris of each GPS satellite, and is obtained by decoding the received GPS satellite signal. In addition, only the data of the almanac may be used only for capturing the GPS satellite, but the data of the ephemeris is required in order to calculate the position of the GPS receiver. The measurement data 243 is data of the code phase and the Doppler frequency for the received GPS satellite signal, and is obtained based on the result of the correlation calculation with the replica code.

The power consumption status determination unit 233 determines the power consumption status of the power supply unit 500. In the present embodiment, the remaining amount of power in the power supply unit 500 is determined as the power consumption status. For example, it is possible to determine the remaining amount of power from the output voltage of the power supply unit 500. The smaller the remaining amount of power is, the lower the output voltage of the power supply unit 500 is.

The operation range setting unit 234 sets an operation range of the intermittent operation, according to the power consumption status of the power supply unit 500 determined by the power consumption status determination unit 233. Specifically, the operation range is set according to the operation range setting table 245, based on the remaining amount of power determined by the power consumption status determination unit 233. The operation range (specifically, an upper limit and a lower limit) which is set by the operation range setting unit 234 is stored as the operation range data 249.

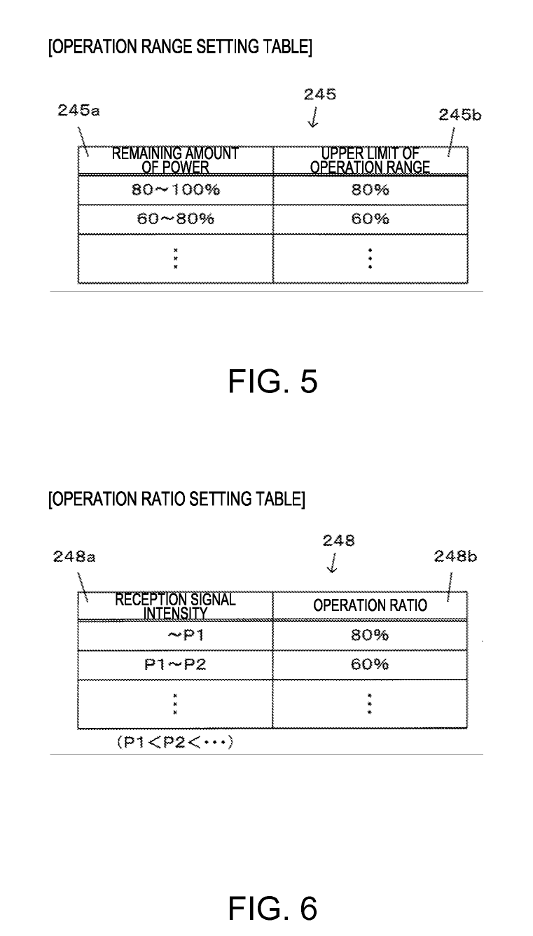

FIG. 5 is a data configuration example of the operation range setting table 245. According to FIG. 5, the operation range setting table 245 stores the remaining amount of power 245a and the upper limit 245b of the operation range in association with each other. It is determined that the smaller the remaining amount of power 245a is, the smaller (lower) the upper limit 245b of the operation range is.

In addition, the operation range is variably set also in response to the data portion of a navigation message which is transported on the GPS satellite signal received from the captured GPS satellite. Specifically, when the data portion of the un-acquired ephemeris is received, in the navigation message, regardless of the determined remaining amount of power, for example, the upper limit of the operation range is set to “100%”. Whether or not the ephemeris is being received can be determined by which data portion of the navigation message the received data is. That is because the data format of the navigation message is defined.

Further, when the latest position calculated by the position calculation unit 232 satisfies a predetermined position condition or when the latest speed satisfies a predetermined speed condition, the operation range of the intermittent operation is variably set. For example, the upper limit of the operation range is set to “100%”.

The position condition is a condition indicating that the GPS receiver 200 is located in a predetermined position, and when the latest position is within a predetermined range including the predetermined position (for example, a range of a radius of 100 m, with the predetermined position as a center), it is determined that the latest position satisfies the position condition. A single, or plural predetermined positions which are the position conditions are stored as position condition data 247. If the upper limit of the operation range of the intermittent operation is set to 100%, for example, the position for which the accuracy and the sensitivity of positioning are desired to be increased may be set to the position condition data 247.

Further, the speed condition is a condition indicating that the movement speed of the GPS receiver 200 is low, and when the latest speed is equal to or less than a predetermined threshold speed that is considered to be a low speed, it is determined that the latest speed satisfies the speed condition. The threshold speed which is the speed condition is stored as the speed condition data 246.

The operation range (specifically, an upper limit and a lower limit) which is set by the operation range setting unit 234 is stored as the operation range data 249.

The operation ratio setting unit 235 sets the operation ratio (duty ratio) of the intermittent operation so as to be within the operation range which is set by the operation range setting unit 234. Specifically, the reception status of the GPS satellite signal is determined. In the present embodiment, it is assumed that reception status is determined by the fifth strongest reception signal intensity among reception signal intensities of GPS satellites captured by the satellite capture unit 231. In addition, the reception status may be determined as an average value of reception signal intensities of respective captured GPS satellites, or may be determined by using a Dilution Of Precision (DOP) value indicating a degree of deterioration in GPS positioning accuracy. The DOP value is determined by the position of the GPS satellite in the sky, and indicates that if the value is smaller, the GPS positioning accuracy may be relatively higher.

Then, the operation ratio of the intermittent operation corresponding to the determined reception signal intensity is determined by referring to the operation ratio setting table 248. If the determined operation ratio is within the operation range, the operation ratio in this case is set to the operation ratio. If the determined operation ratio is out of the operation range, the upper limit of the operation range is set to the operation ratio. The operation ratio which is set by the operation ratio setting unit 235 is stored as the operation ratio data 250.

FIG. 6 is a data configuration example of the operation ratio setting table 248. According to FIG. 6, the operation ratio setting table 248 stores the reception signal intensity 248a and the operation ratio 248b in association with each other. It is determined that the greater (stronger) the reception signal intensity 248a is, the smaller the operation ratio 248b is.

The intermittent drive control unit 236 controls the intermittent drive of the RF reception circuit unit 210 and the baseband processing circuit unit 220 with the operation ratio which is set by the operation ratio setting unit 235.

The BB storage unit 240 is configured with a ROM, a RAM, and the like, stores a system program by which the BB processing unit 230 generally controls the baseband processing circuit unit 220 and programs and data for implementing various functions, is used as a work area of the BB processing unit 230, and temporarily stores an operation result of the BB processing unit 230, and the like. In the present embodiment, the BB storage unit 240 stores the baseband program 241, the satellite orbit data 242, the measurement data 243, the calculation result data 244, the operation range setting table 245, the speed condition data 246, the position condition data 247, the operation ratio setting table 248, the operation range data 249, and the operation ratio data 250. It is possible to obtain the satellite orbit data 242 by decoding the navigation message carried on the GPS satellite signal.

### Flow of Process

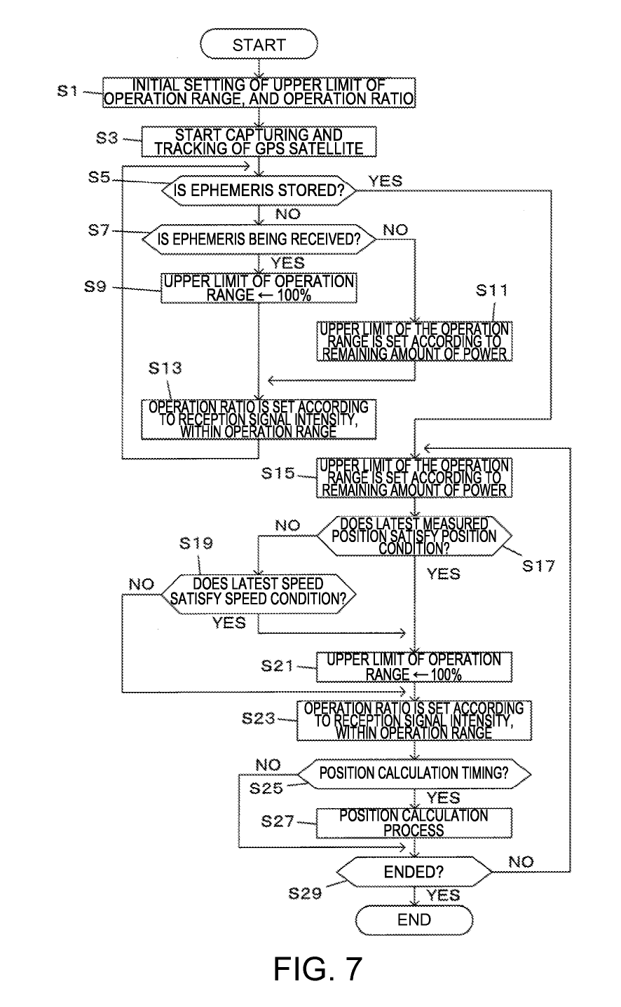

FIG. 7 is a flowchart describing a flow of a baseband process. The process is performed by the BB processing unit 230 according to the baseband program 241.

First, the operation range setting unit 234 performs an initial setting (for example, 0 to 80%) of the operation range, and the operation ratio setting unit 235 performs an initial setting (for example, 80%) of the operation ratio (step S1). Next, the satellite capture unit 231 selects a GPS satellite to be captured (captured satellite) by referring to the satellite orbit data 242 or the like, and starts capturing and tracking of the GPS satellite (step S3).

Subsequently, the operation range setting unit 234 determines whether the ephemeris of each captured satellite is stored as the satellite orbit data 242. If there is a captured satellite of which the ephemeris is not stored (step S5: NO), it is determined whether or not the data carried on the GPS satellite signal received from the captured satellite is a data portion of the ephemeris which is not stored. If the ephemeris is being received (step S7: YES), the upper limit of the operation range is set to “100%” (step S9). If the ephemeris is not being received (step S7: NO), according to the remaining amount of power (power consumption status) in the power supply unit 500, the upper limit of the operation range is set (step S11). Then, the operation ratio setting unit 235 sets the operation ratio of the intermittent operation in response to the reception signal intensity of the GPS satellite signal (step S13). Thereafter, the process returns to step S5.

Meanwhile, if the ephemeris of each captured satellite is not stored (step S5: YES), the operation range setting unit 234 sets the upper limit of the operation range of the intermittent operation according to the remaining amount of power (power consumption status) in the power supply unit 500 (step S15). Subsequently, when the latest position by the position calculation unit 232 satisfies the position condition (step S17: YES), or the latest speed calculated by the position calculation unit 232 satisfies the speed condition (step S19: YES), the operation range setting unit 234 sets the upper limit of the operation range to “100%” (step S21). Thereafter, the operation ratio setting unit 235 sets the operation ratio of the intermittent operation, according to the reception signal intensity of the GPS satellite signal (step S23).

Further, at the position calculation timing after a predetermined time interval (for example, one second interval) has elapsed (step S25: YES), the position calculation unit 232 performs the position calculation process and calculates the position and the speed of the GPS receiver 200 (portable electronic device 1) (step S27). Thereafter, the BB processing unit 230 determines whether the baseband process is ended, and if the process is not ended (step S29: NO), the process returns to step S15, and if the process is ended (step S29: YES), the baseband process is ended.

### Operation Effect

In this manner, according to the portable electronic device 1 of the present embodiment, according to the power consumption status of the power supply unit 500, the upper limit of the operation range of the intermittent operation (duty control) of the GPS receiver 200 is variably set. Thus, for example, if the remaining amount of power is reduced, the upper limit of the operation range is set to be low, such that the consumed power required for the intermittent operation is reduced, and as a result, it is possible to extend the operation time of the GPS receiver 200 (also the portable electronic device 1).

### Modification Example

In addition, the applicable embodiment of the invention is not limited to the embodiment described above, and it is of course that the invention may be appropriately changed without departing from the scope of the invention.

### A. Power Consumption Status of Power Supply Unit 500

For example, the output voltage of the power supply unit 500 and the positioning operation time may be determined as the power consumption status of the power supply unit 500. The output voltage of the power supply unit 500 decreases with a decrease in the remaining amount of power.

Therefore, for example, the threshold of the output voltage corresponding to the remaining amount of power (for example, 20%) that is considered to be “small” is preset, and if the output voltage of the power supply unit 500 is less than the threshold voltage, the upper limit of the operation range is set to be low.

Further, the positioning operation time is the accumulated time of the positioning operation (position calculation operation) of the GPS receiver 200 from a time point when the power supply unit 500 is fully charged. With an increase in the positioning operation time, the remaining amount of power in the power supply unit 500 is reduced. Therefore, for example, the positioning operation time corresponding to the remaining amount of power (for example, 20%) that is considered to be “small” is preset as a threshold time, and if the positioning operation time reaches the threshold time, the upper limit of the operation range is set to be low. In addition, the start and end of the positioning operation by the GPS receiver 200 is controlled by the main processing unit 300.

### B. Subject of Process

Further, the description has been given of the case in which the baseband processing circuit unit 220 performs the setting of the operation range of the intermittent operation and the drive control of the intermittent operation in the embodiments described above, but may be performed by the main processing unit 300 that controls the operation of the portable electronic device 1.

### C. Electronic Device

Further, the case in which the invention is applied to the runner's watch which is a kind of electronic device is described as an example in the embodiments described above, but the electronic devices to which the invention is applicable are not limited thereto, and it is possible to apply the invention to various electronic devices such as car navigation devices, portable navigation devices, personal computers, Personal Digital Assistants (PDA), and mobile phones.

### D. Satellite Positioning System

Further, in the embodiments described above, the GPS is used as an example of the satellite positioning system, but other satellite positioning systems such as a Wide Area Augmentation System (WAAS), a Quasi Zenith Satellite System (QZSS), a GLObal NAvigation Satellite System (GLONASS), GALILEO, and a BeiDou Navigation Satellite System (BeiDou) may be used.

What is claimed is:

1. A drive control method of a reception unit comprising:
setting an intermittent operation range including an upper limit of an operation ratio of the reception unit, based on power consumption status of a power supply unit that supplies the reception unit which receives a positioning signal with power; and
causing the reception unit to perform an intermittent operation within the intermittent operation range.

2. The drive control method of a reception unit according to claim 1,
wherein the setting is setting the intermittent operation range by determining the power consumption status by using the remaining amount of power in the power supply unit.

3. The drive control method of a reception unit according to claim 1,
wherein the setting is setting the intermittent operation range by determining the power consumption status by using an output voltage of the power supply unit.

4. The drive control method of a reception unit according to claim 1,
wherein the setting is setting the intermittent operation range by determining the power consumption status by using a positioning operation time.

5. The drive control method of a reception unit according to claim 1, further comprising:
setting the intermittent operation range, based on a movement speed measured by using the positioning signal.

6. The drive control method of a reception unit according to claim 1, further comprising:
setting the intermittent operation range, based on whether a position measured by using the positioning signal satisfies a predetermined position condition.

7. The drive control method of a reception unit according to claim 1, further comprising:
variably setting the intermittent operation range, according to a data portion of a navigation message carried on the positioning signal which is received by the reception unit.

8. A positioning device comprising:
a reception unit that receives a positioning signal;
a power supply unit that supplies the reception unit with power;
a setting unit that sets an intermittent operation range including an upper limit of an operation ratio of the reception unit, based on power consumption status of the power supply unit; and
a control unit that causes the reception unit to perform an intermittent operation within the intermittent operation range.
